(19) United States
(12) Patent Application Publication
(10) Pub. No.: US 2026/0024274 A1
(43) Pub. Date: Jan. 22, 2026

(54) DEPTH-BASED REPROJECTION WITH ADAPTIVE DEPTH DENSIFICATION AND SUPER-RESOLUTION FOR VIDEO SEE-THROUGH (VST) EXTENDED REALITY (XR) OR OTHER APPLICATIONS

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 19/078,057

(22) Filed: Mar. 12, 2025

Related U.S. Application Data
(60) Provisional application No. 63/672,659, filed on Jul. 17, 2024.

(51) Int. Cl. G06T 15/20; G06T 3/4053

(52) U.S. Cl. CPC G06T 15/205; G06T 3/4053

(57) ABSTRACT

A method includes obtaining a first image frame captured at a first time and first depth data associated with the first image frame, where the first image frame has a higher resolution than the first depth data. The method also includes predicting motion of the electronic device between the first time and a second time and generating second depth data based on the first depth data, the first image frame, and the predicted motion, where the second depth data has a higher resolution than the first depth data. The method further includes reprojecting the first image frame using the second depth data to generate a second image frame and displaying a rendered image based on the second image frame. Generating the second depth data includes performing depth densification and super-resolution in order to increase the resolution of the second depth data relative to the resolution of the first depth data.

### CROSS-REFERENCE TO RELATED APPLICATION AND PRIORITY CLAIM

This application claims priority under 35 U.S.C. § 119(e) to U.S. Provisional Patent Application No. 63/672,659 filed on Jul. 17, 2024. This provisional patent application is hereby incorporated by reference in its entirety.

### TECHNICAL FIELD

This disclosure relates generally to image processing systems and processes. More specifically, this disclosure relates to depth-based reprojection with adaptive depth densification and super-resolution for video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to depth-based reprojection with adaptive depth densification and super-resolution for video see-through (VST) extended reality (XR) or other applications.

In a first embodiment, an apparatus includes at least one display, at least one imaging sensor configured to capture image frames of a scene, and at least one motion sensor configured to sense motion of the apparatus. The apparatus also includes at least one processing device configured to obtain a first image frame captured at a first time and first depth data associated with the first image frame, where the first image frame has a higher resolution than the first depth data. The at least one processing device is also configured to predict motion of the apparatus between the first time and a second time and generate second depth data based on the first depth data, the first image frame, and the predicted motion, where the second depth data has a higher resolution than the first depth data. The at least one processing device is further configured to reproject the first image frame using the second depth data to generate a second image frame and initiate presentation of a rendered image based on the second image frame, where the at least one display is configured to present the rendered image substantially at the second time. To generate the second depth data, the at least one processing device is configured to perform depth densification and super-resolution in order to increase the resolution of the second depth data relative to the resolution of the first depth data.

In a second embodiment, a method includes obtaining, using at least one imaging sensor of an electronic device, a first image frame captured at a first time and first depth data associated with the first image frame, where the first image frame has a higher resolution than the first depth data. The method also includes predicting, using at least one processing device of the electronic device, motion of the electronic device between the first time and a second time. The method further includes generating, using the at least one processing device, second depth data based on the first depth data, the first image frame, and the predicted motion, where the second depth data has a higher resolution than the first depth data. The method also includes reprojecting, using the at least one processing device, the first image frame using the second depth data to generate a second image frame. In addition, the method includes displaying, using at least one display of the electronic device, a rendered image based on the second image frame. Generating the second depth data includes performing depth densification and super-resolution in order to increase the resolution of the second depth data relative to the resolution of the first depth data.

In a third embodiment, a non-transitory machine readable medium contains instructions that when executed cause at least one processor of an electronic device to obtain, using at least one imaging sensor of the electronic device, a first image frame captured at a first time and first depth data associated with the first image frame, where the first image frame has a higher resolution than the first depth data. The non-transitory machine readable medium also contains instructions that when executed cause the at least one processor to predict motion of the electronic device between the first time and a second time and generate second depth data based on the first depth data, the first image frame, and the predicted motion, where the second depth data has a higher resolution than the first depth data. The non-transitory machine readable medium further contains instructions that when executed cause the at least one processor to reproject the first image frame using the second depth data to generate a second image frame and initiate display of a rendered image based on the second image frame. The instructions that when executed cause the at least one processor to generate the second depth data include instructions that when executed cause the at least one processor to perform depth densification and super-resolution in order to increase the resolution of the second depth data relative to the resolution of the first depth data.

Any one or any combination of the following features may be used with the first, second, or third embodiment. The resolution of the second depth data may match or substantially match the resolution of the first image frame. A feature map may be generated based on the first image frame, and the feature map may be used during depth densification and super-resolution. During depth densification and super-resolution, first depth values of the first depth data may be mapped onto a first set of points, second depth values may be generated, and the second depth values may be mapped onto a second set of points such that the first depth values and the second depth values together form at least part of the second depth data. Depth densification may be performed to generate additional depth values not included among the first depth values of the first depth data, and depth super-resolution may be performed to upscale the first depth values and the additional depth values in order to generate the second depth values. A depth filter may be used to generate the additional depth values based on (i) neighboring first depth values of the first depth data, (ii) information from the first image frame, and (iii) the feature map. Depth densification may be performed using (i) image feature information from the feature map and (ii) at least one of: spatial information, image color texture information, or temporal information from the first image frame. To perform depth densification and super-resolution, at least one of image correspondence or image feature correspondence between the first image frame and a third image frame may be used, where the first and third image frames represent left and right image frames of a stereo pair of image frames.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for depth-based reprojection with adaptive depth densification and super-resolution for video see-through (VST) extended reality (XR) or other applications in accordance with this disclosure;

FIG. 3 illustrates an example architecture for depth-based reprojection with adaptive depth densification and super-resolution for VST XR or other applications in accordance with this disclosure;

FIGS. 4A through 4C illustrate example operations in the process of FIG. 2 and/or the architecture of FIG. 3 in accordance with this disclosure;

FIG. 5 illustrates an example technique for final passthrough image frame generation in accordance with this disclosure;

FIG. 6 illustrates an example adaptive depth densification and super-resolution in accordance with this disclosure;

FIG. 7 illustrates example image correspondences for adaptive depth densification and super-resolution in accordance with this disclosure;

FIG. 8 illustrates example image feature correspondences for adaptive depth densification and super-resolution in accordance with this disclosure; and

FIG. 9 illustrates an example method for depth-based reprojection with adaptive depth densification and super-resolution for VST XR or other applications in accordance with this disclosure.

### DETAILED DESCRIPTION

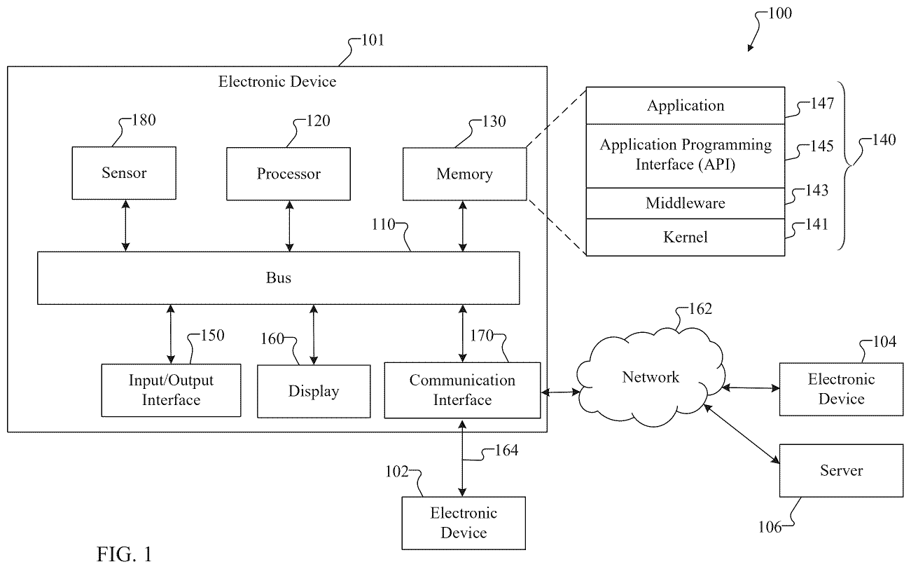

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that image frames are captured using one or more imaging sensors that are located at positions other than the user's eyes. Moreover, the user's head may change locations in between when image frames are captured and when corresponding images are rendered and displayed, which is often referred to as user head pose changes. These issues can make it necessary or desirable to reproject captured image frames in order to account for these or other factors.

Depth-based reprojection may be used to reproject captured image frames, at least in certain circumstances. However, while some XR headsets or other devices may be equipped with depth sensors (such as time-of-flight or LIDAR sensors) or may acquire depth data (such as via stereo image processing), this generally results in low-resolution and noisy sparse depth data, such as 320×320 or similar depth maps. Accurate depth-based reprojection may need much higher-resolution depth data, such as depth data that is the same as or similar to the resolution of the image frames being reprojected (such as a resolution of up to 3,000×3,000 or even higher). The quality of the depth data can have a direct impact on the quality of the rendered images that are presented to the user.

This disclosure provides various techniques supporting depth-based reprojection with adaptive depth densification and super-resolution for VST XR or other applications. As described in more detail below, a first image frame captured at a first time and first depth data associated with the first image frame can be obtained using an electronic device. The first image frame can have a higher resolution than the first depth data. Motion of the electronic device between the first time and a second time can be predicted, and second depth data can be generated based on the first depth data, the first image frame, and the predicted motion. The second depth data can have a higher resolution than the first depth data. The second depth data can be generated by performing depth densification and super-resolution in order to increase the resolution of the second depth data relative to the resolution of the first depth data. The first image frame can be reprojected using the second depth data to generate a second image frame, and a rendered image based on the second image frame can be displayed.

In this way, the disclosed techniques provide for improved depth-based reprojection of image frames. Among other things, the disclosed techniques support new approaches for depth-based reprojection with adaptive depth densification and super-resolution, which in some cases may be used to generate final views of scenes for VST XR devices. The disclosed techniques can integrate head pose change compensation, depth densification, and depth super-resolution efficiently. Adaptive depth densification and super-resolution can be used to generate high-quality and high-resolution depth maps or other dense depth data from captured lower-resolution depth data for use during depth-based reprojection, and information from the image frames being reprojected (such as image color information and/or image feature information) can be used to guide the generation of the high-resolution depth data. Among other things, these techniques can be used to improve the generation of rendered images for VST XR or other applications. In some instances, for example, the disclosed techniques can be used to perform frame interpolation (such as to increase the frame rate in VST XR pipelines or other image processing pipelines) or to make video sequences of rendered images appear smoother (such as by reducing latency or motion artifacts).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to depth-based reprojection with adaptive depth densification and super-resolution for VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform depth-based reprojection with adaptive depth densification and super-resolution for VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to depth-based reprojection with adaptive depth densification and super-resolution for VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

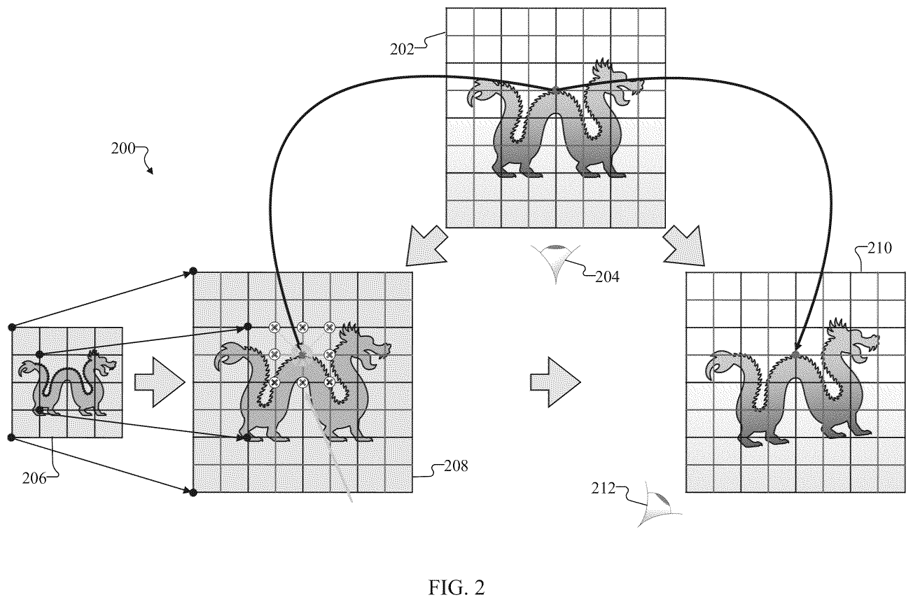

FIG. 2 illustrates an example process 200 for depth-based reprojection with adaptive depth densification and super-resolution for VST XR or other applications in accordance with this disclosure. For case of explanation, the process 200 shown in FIG. 2 is described as being performed using the electronic device 101 in the network configuration 100 shown in FIG. 1. However, the process 200 may be performed using any other suitable device(s) and in any other suitable system(s).

As shown in FIG. 2, a first image frame 202 is captured while the user has a first pose 204. The first image frame 202 may be captured using at least one imaging sensor 180 of the electronic device 101. The first pose 204 relates to the position and orientation of the user's head when the first image frame 202 is captured. First depth data 206, which may have the form of a first depth map, is associated with the first image frame 202. The first depth data 206 may be captured using at least one depth sensor 180 of the electronic device 101 or calculated by the processor 120 of the electronic device 101. The first depth data 206 has a lower resolution (and potentially a much lower resolution) than the first image frame 202. For example, in some embodiments, the first image frame 202 may have a resolution of up to 3,000×3,000 pixels, 4,000×4,000 pixels, or even more, while the first depth data 206 may have a resolution of 320×240, 320×320, 480×480, or other lower resolution.

Using the techniques described below, the first image frame 202 and the first depth data 206 can be used to generate second depth data 208, which may have the form of a second depth map. The second depth data 208 can have a higher resolution (and potentially a much higher resolution) than the first depth data 206. In some cases, for example, the second depth data 208 can have a resolution that is the same as or substantially similar to the resolution of the first image frame 202. The first depth data 206 may be referred to as sparse depth data, and the second depth data 208 may be referred to as dense depth data.

As described in more detail below, an adaptive algorithm can be used to perform depth densification and super-resolution in order to generate the second depth data 208, such as to estimate depths at points where depth values are missing (unknown) in the first depth data 206. The depth densification and super-resolution algorithm can adaptively adopt information from the first image frame 202 and optionally image correspondences and/or image feature correspondences between the first image frame 202 and another image frame to obtain high-quality depth values within the second depth data 208. Among other things, the second depth data 208 can provide clear object boundaries within the scene captured in the first image frame 202.

With higher-quality second depth data 208, a depth-based reprojection can be performed to reproject the first image frame 202 into a second image frame 210. The reprojection allows the second image frame 210 to appear as if it was captured while the user has a second pose 212. In some cases, the second pose 212 may relate to the estimated position and orientation of the user's head when a rendered image based on the second image frame 210 will be displayed to the user. The second pose 212 can therefore represent a head pose of the user that differs from the first pose 204. Note that the second depth data 208 can be generated here in a manner that integrates head pose change compensation, depth densification, and depth-super-resolution together, which allows the second image frame 210 to be generated in a more efficient manner. For instance, the second image frame 210 can be generated using fewer processing resources and/or memory resources.

The process 200 shown in FIG. 2 can be repeated for any number of image frames. For example, the process 200 shown in FIG. 2 can be repeated using multiple image frames (such as in one or more sequences of image frames) in order to generate images that can be displayed to a user of the electronic device 101, which in some cases may represent an XR device. Thus, for instance, image frames captured using left and right see-through cameras (imaging sensors 180) of the XR device may be processed in this manner in order to provide rendered images to the left and right eyes of the user.

Although FIG. 2 illustrates one example of a process 200 for depth-based reprojection with adaptive depth densification and super-resolution for VST XR or other applications, various changes may be made to FIG. 2. For example, the resolutions of the image frames and depth data are not drawn to scale here and can easily vary depending on the implementation.

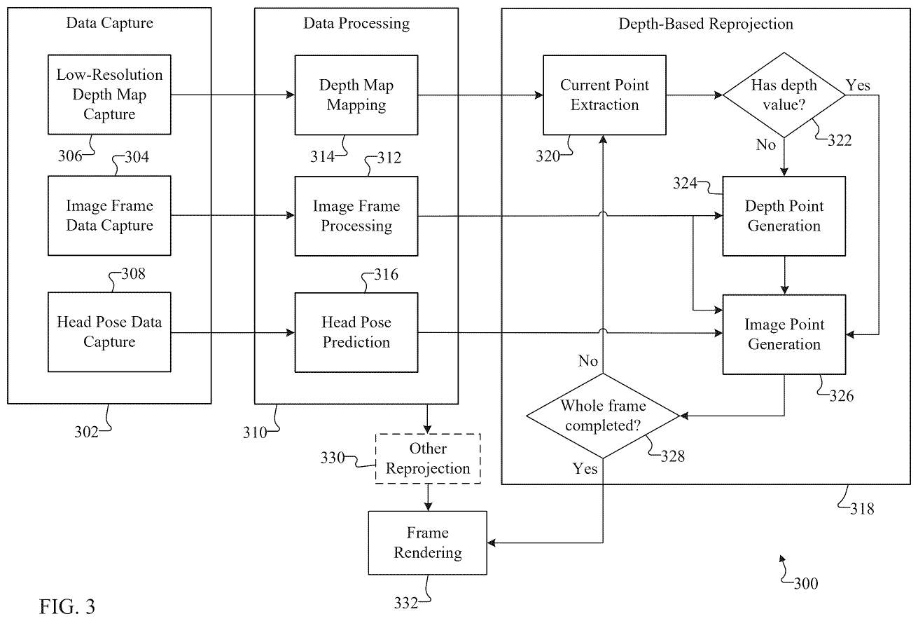

FIG. 3 illustrates an example architecture 300 for depth-based reprojection with adaptive depth densification and super-resolution for VST XR or other applications in accordance with this disclosure. For ease of explanation, the architecture 300 shown in FIG. 3 is described as being implemented using the electronic device 101 in the network configuration 100 shown in FIG. 1, where the electronic device 101 may implement the process 200 shown in FIG. 2. However, the architecture 300 may be implemented using any other suitable device(s) and in any other suitable system(s), and the architecture 300 may be used to implement any other suitable process(es) designed in accordance with this disclosure.

As shown in FIG. 3, the architecture 300 includes a data capture operation 302, which generally operates to obtain data to be processed using the architecture 300. In this example, the data capture operation 302 includes an image frame capture function 304, a low-resolution depth map capture function 306, and a head pose data capture function 308. The image frame capture function 304 generally operates to obtain image frames of a scene. For example, the image frame capture function 304 can be used to obtain image frames 202 captured using one or more see-through cameras or other imaging sensors 180 of a VST XR device or other electronic device 101. In some cases, the image frame capture function 304 may be used to obtain image frames at a desired frame rate, such as 30, 60, 90, or 120 frames per second. The image frame capture function 304 may also be used to obtain image frames from any suitable number of imaging sensors 180, such as from left and right see-through cameras. Each image frame can have any suitable size, shape, and resolution and include image data in any suitable domain. As particular examples, each image frame may include RGB image data, YUV image data, or Bayer or other raw image data.

The image frame capture function 304 may also optionally operate to obtain other image frames. For example, in some cases, the image frame capture function 304 may be used to obtain image frames capturing a user's eyes. In some embodiments, the electronic device 101 may include one or more eye-tracking cameras or other imaging sensors 180 directed towards the user's eyes. These imaging sensors 180 may be used to capture high-resolution or other image frames of the user's eyes. In some cases, the user's eyes may be illuminated, such as by infrared or other illumination sources, while the imaging sensors 180 capture the image frames of the user's eyes. These image frames may be used to estimate the direction in which the user is gazing and the focal distance of the user's eyes, such as based on reflections of the infrared or other illumination from the user's eyes. As a particular example, a Pupil Center Corneal Reflection (PCCR) technique may be used to estimate the direction in which the user is gazing and the focal distance of the user's eyes.

The low-resolution depth map capture function 306 generally operates to obtain lower-resolution depth data associated with at least some of the captured image frames obtained by the image frame capture function 304. For example, the low-resolution depth map capture function 306 can be used to obtain lower-resolution depth data, such as depth maps or other depth data 206 captured using one or more time-of-flight, LIDAR, or other depth sensors 180 of the VST XR device or other electronic device 101. The lower-resolution depth data may also or alternatively include depth values that are estimated computationally, such as depth values that are estimated using disparity estimation based on stereo pairs of lower-resolution image frames. In some cases, the low-resolution depth map capture function 306 can obtain individual depth data 206 for each image frame 202 of a scene. In other cases, the low-resolution depth map capture function 306 can obtain depth data 206 that is shared across multiple image frames 202, such as when the same depth data 206 applies to left and right image frames 202 of a scene captured at the same time or when the same depth data 206 applies to multiple sequential image frames 202 of a scene captured while the user is not moving his or her head significantly. As noted above, the depth data here can have a resolution that is less than (and possibly significantly less than) the resolution of the captured image frames of a scene.

The head pose data capture function 308 generally operates to obtain information related to the pose of the user's head while the electronic device 101 is being used. The head pose information may be obtained from any suitable source(s), such as from one or more positional sensors 180 of the electronic device 101 (like at least one IMU). In some cases, the head pose information may be expressed using six degrees of freedom, such as three translation values and three rotation values. The three translation values may identify movement of the user's head along three orthogonal axes, and the three rotation values may identify rotation of the user's head about the three orthogonal axes. Note, however, that the head pose information may have any other suitable form. Among other things, the head pose information can identify the current head pose of the user when each image frame 202 is captured.

A data processing operation 310 generally operates to process the captured image frames, low-resolution depth data, and head pose data in order to prepare for subsequent depth-based reprojection or other processing of the image frames. In this example, the data processing operation 310 includes an image frame processing function 312, a depth map mapping function 314, and a head pose prediction function 316. The image frame processing function 312 generally operates to process the captured image frames in order to generate pre-processed versions of the image frames. For example, the image frame processing function 312 may perform noise reduction, de-blurring, image enhancement, or any combination thereof. This can result in the generation of image frames that are clearer and more suitable for depth-based reprojection (if needed).

The depth map mapping function 314 generally operates to map depth values from the obtained low-resolution depth data to a higher-resolution but still sparse depth map. For example, since depth data 206 has a lower resolution than an associated image frame 202, the depth map mapping function 314 can map the depth values from the depth data 206 onto a first set of points within a higher-resolution depth map. Those points correspond to locations where the depth data 206 identifies actual depths. As described below, during depth densification and super-resolution, additional depth values can be mapped onto a second set of points within the higher-resolution depth map, and all of the depth values can be subjected to upscaling. This allows the depth values at the first and second sets of points to form at least part of the (denser) depth data 208 for that image frame 202.

The head pose prediction function 316 generally operates to estimate what the user's head pose will likely be when rendered images are actually displayed to the user. In many cases, for instance, an image frame will be captured at one time, and a rendered image will be subsequently displayed to the user some amount of time later. It is possible for the user to move his or her head during this intervening time period. The head pose prediction function 316 can therefore be used to estimate, for each image frame, what the user's head pose will likely be when a rendered image based on that image frame will be displayed to the user. The head pose prediction function 316 may use any suitable technique(s) to predict the user's head pose, such as by using a head pose motion model that predicts the future pose of the user's head based on prior and current information about the user's head pose.

At least some of the image frames can be subjected to a depth-based reprojection operation 318, which generally operates to reproject each of those image frames based on depth information in order to generate a reprojected image frame. In this example, the depth-based reprojection operation 318 includes a current point extraction function 320, which generally operates to identify each pixel of a corresponding image frame being reprojected. A decision function 322 determines whether there is already depth data for that extracted pixel. Depending on the position of the pixel in an image frame 202 and the depth data 206 for that image frame 202, there may or may not be a corresponding depth value in the depth data 206 that has been mapped to the higher-resolution depth map. The decision function 322 can therefore determine whether an existing depth value is already available for the extracted pixel. If not, the depth-based reprojection operation 318 can perform a depth point generation function 324. Otherwise, the depth-based reprojection operation 318 can skip to an image point generation function 326.

The depth point generation function 324 generally operates to create a depth value for the extracted pixel. The depth point generation function 324 here can perform adaptive depth densification and super-resolution in order to generate a depth value for the current point in the image frame 202. In some embodiments, for example, the depth point generation function 324 may create and use a depth filter to generate each depth value. The depth filter can be configured to use depth values in a neighborhood around the current point in the image frame 202. The depth filter can also optionally be guided based on information from the image frame 202 and/or a feature map generated using the image frame 202. As a particular example, image correspondences and/or image feature correspondences between the image frame 202 and another image frame can be used by the depth filter. This allows the depth filter to consider neighboring depth values and optionally image correspondences and/or image feature correspondences when generating additional depth values. Among other things, the depth filter can both (i) generate additional depth values accurately and with clear object boundaries at depth unknown points and (ii) remove noise at points having noisy depths.

The image point generation function 326 generally operates to reproject the extracted pixel from the image frame 202 based on the depth for that extracted pixel. The depth for that extracted pixel may come from the actual depth data 206 or be generated by the depth point generation function 324. The image point generation function 326 can therefore be used to generate a pixel in a reprojected image frame 210 corresponding to the current point of the image frame 202.

A decision function 328 determines whether all pixels of the image frame 202 have been processed. If not, the current point extraction function 320 can be used to extract the next pixel from the image frame 202 for processing and reprojection. By repeating this process across all pixels of the image frame 202, the depth-based reprojection operation 318 can be used to generate a complete reprojected image frame 210. Moreover, this can be accomplished while simultaneously providing head pose change compensation, depth densification, and depth super-resolution. In addition, this approach does not require computation, storage, and use of large depth maps, which can reduce processing resource requirements and/or memory resource requirements.

Note that the depth-based reprojection operation 318 may be implemented in any suitable manner. For instance, at least part of the depth-based reprojection operation 318 may be implemented using a trained machine learning model, such as a trained deep neural network (DNN). As a particular example, the generation of dense depth data may be performed using a trained machine learning model, such as a DNN. In these embodiments, a machine learning model could include an input layer, encoding layers, decoding layers, and a linear layer. One or more datasets could be created or otherwise obtained with sample images and ground truth depth data, and the one or more datasets can be used to train the machine learning model to learn relationships between the sample images and the depth data. After training, high-resolution depth data can be obtained using the trained machine learning model. Depth verification and correction can also be incorporated to refine the depth data generated by the trained machine learning model.

In the description above, it is noted that at least some of the image frames can be subjected to the depth-based reprojection operation 318. In some embodiments, depth-based reprojection may or may not be needed for all image frames 202 being processed, depending on the circumstances. For example, one or more other reprojections 330 may be applied to one or more of the captured image frames 202. Any other suitable types of reprojections 330 may be used here. As a particular example, if the user's head pose does not change (at least by a threshold amount), no reprojection may be needed for image frames 202 captured during the time that the user's head pose does not change significantly. If the user's head pose only changes by rotation, a time warp reprojection can be performed (which may not involve the use of depth data). If the user focuses on a planar object like a monitor or television, a planar reprojection can be performed (which may not involve the use of depth data). If the user focuses on a 3D object, the depth-based reprojection operation 318 can be performed. If no depth data is available, planar reprojection or time warp reprojection may be performed (which may not involve the use of depth data).

A frame rendering operation 332 generally operates to create final views of a scene captured in image frames (either original, pre-processed, or reprojected image frames). The frame rendering operation 332 can also render the final views for presentation to a user of the electronic device 101. For example, the frame rendering operation 332 may process the image frames and perform any additional refinements or modifications needed or desired, and the resulting images can represent the final views of the scene. For instance, a 3D-to-2D warping can be used to warp the final views of the scene into 2D images. The frame rendering operation 332 can also present the rendered images to the user. For example, the frame rendering operation 332 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

Although FIG. 3 illustrates one example of an architecture 300 for depth-based reprojection with adaptive depth densification and super-resolution for VST XR or other applications, various changes may be made to FIG. 3. For example, various operations or functions in FIG. 3 may be combined, further subdivided, replicated, omitted, or rearranged and additional components or functions may be added according to particular needs.

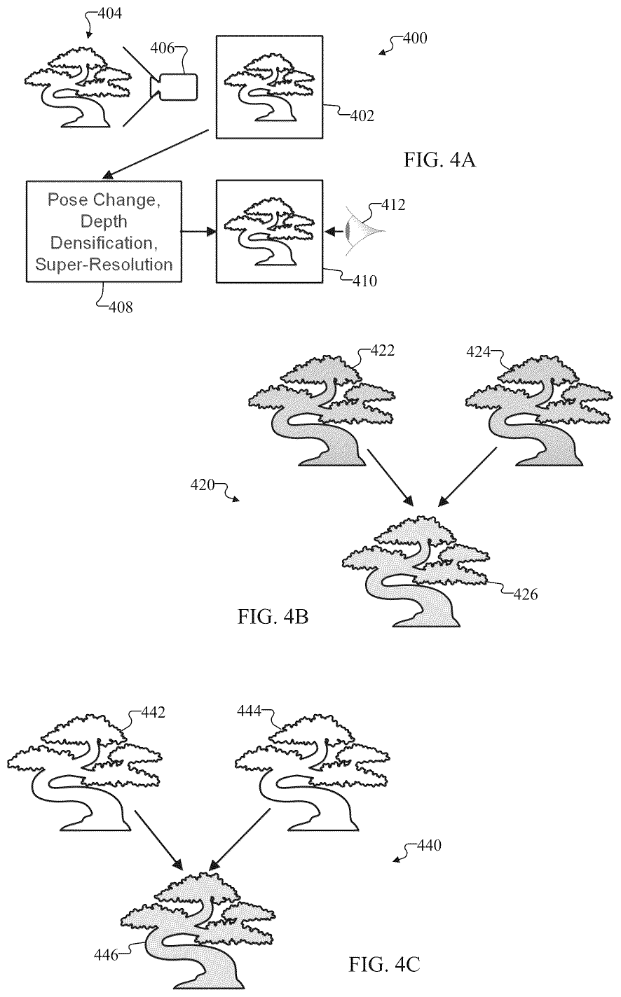

FIGS. 4A through 4C illustrate example operations in the process 200 of FIG. 2 and/or the architecture 300 of FIG. 3 in accordance with this disclosure. As shown in FIG. 4A, one of the operations is a reprojection operation 400 in which image frames 402 of one or more scenes 404 are captured using one or more see-through cameras 406 or other imaging sensors 180 of the electronic device 101. A reprojection operation 408 generates reprojected image frames 410 of the scene(s) 404, where the reprojected image frames 410 have the appearance of being captured at one or more user poses 412. The reprojection operation 408 here supports the generation of final views simultaneously with adaptive depth densification, depth super-resolution, and head pose change compensation.

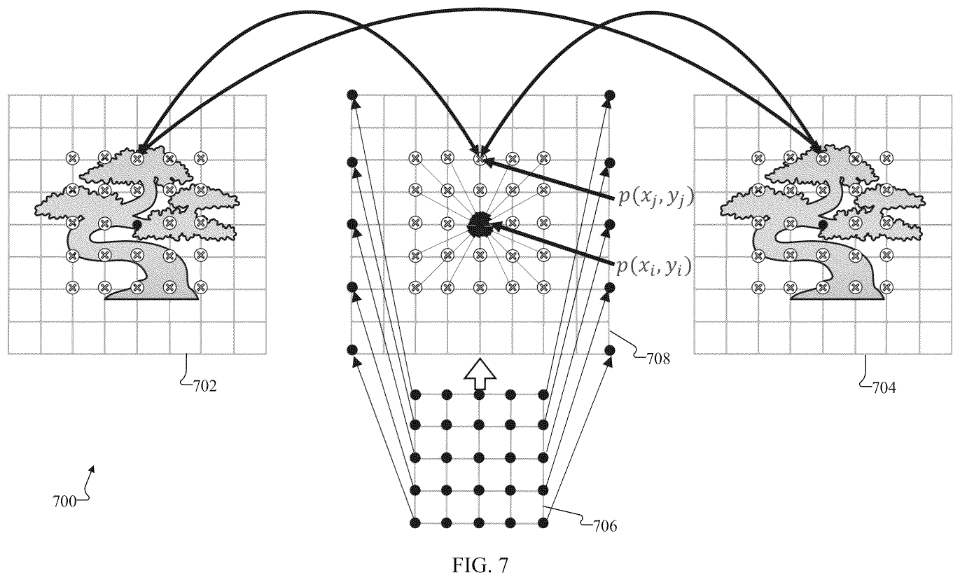

As shown in FIG. 4B, another of the operations is an image correspondence adoption operation 420, which in some cases may be used as part of the reprojection operation 408. The image correspondence adoption operation 420 can dynamically adopt image correspondences between multiple image frames 422 and 424 (such as left and right image frames in stereo pairs of image frames captured using left and right see-through cameras). This can help to increase the accuracy of the depth densification and super-resolution process to obtain more accurate depth values. One example approach for image correspondence adoption is shown in FIG. 7, which is described below.

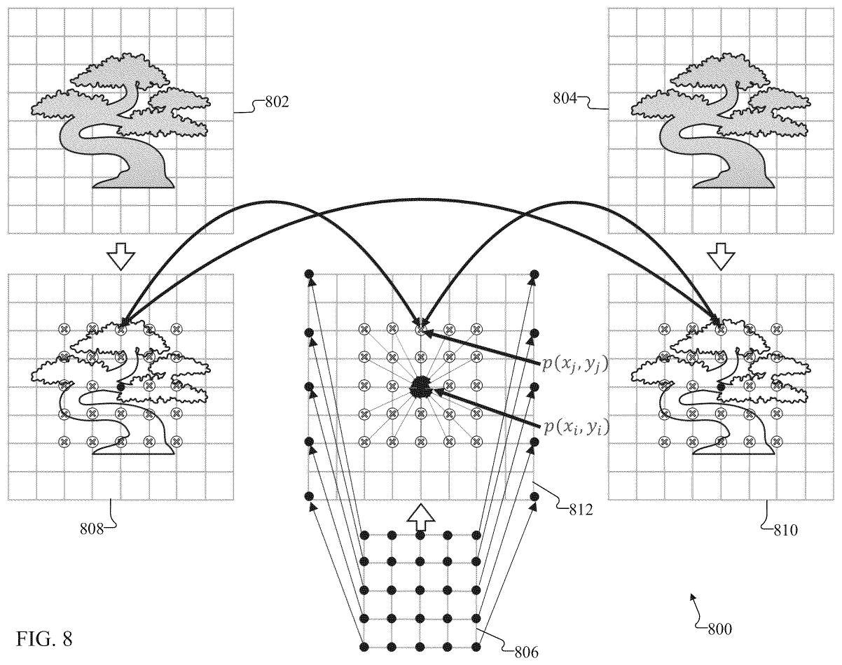

As shown in FIG. 4C, yet another of the operations is an image feature correspondence adoption operation 440, which in some cases may be used as part of the reprojection operation 408. The image feature correspondence adoption operation 440 can dynamically adopt feature correspondences between multiple feature maps 442 and 444, which can be associated with multiple image frames (such as left and right image frames in stereo pairs of image frames captured using left and right see-through cameras). Again, this can help to increase the accuracy of the depth densification and super-resolution process to obtain more accurate depth values. One example approach for image feature correspondence adoption is shown in FIG. 8, which is described below.

Although FIGS. 4A through 4C illustrate examples of operations in the process 200 of FIG. 2 and/or the architecture 300 of FIG. 3, various changes may be made to FIGS. 4A through 4C. For example, not all of the illustrated operations 400, 420, 440 need to be used in any given implementation of the process 200 of FIG. 2 or in any given implementation of the architecture 300 of FIG. 3. As particular examples, the reprojection operation 400 may be used with none, one, or both of the image correspondence adoption operation 420 and the image feature correspondence adoption operation 440.

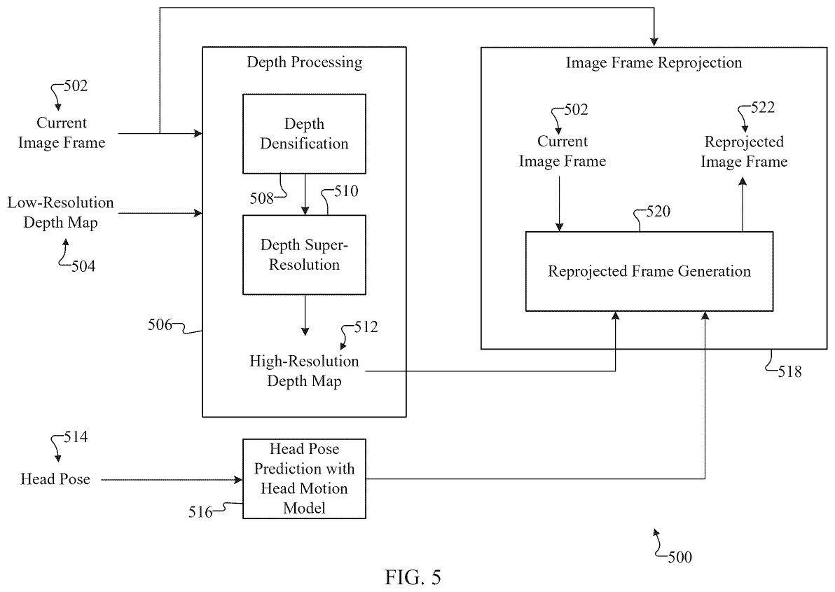

FIG. 5 illustrates an example technique 500 for final passthrough image frame generation in accordance with this disclosure. The technique 500 may, for example, be performed as part of the depth-based reprojection operation 318. For ease of explanation, the technique 500 shown in FIG. 5 is described as being performed using the electronic device 101 in the network configuration 100 shown in FIG. 1, where the electronic device 101 may implement the process 200 shown in FIG. 2 and/or the architecture 300 shown in FIG. 3. However, the technique 500 may be performed using any other suitable device(s) and in any other suitable system(s), and the technique 500 may be used to implement any other suitable process(es) or architecture(s).

As shown in FIG. 5, an image frame 502 (which may represent an image frame 202 or a pre-processed version thereof) and a low-resolution depth map 504 (which may represent depth data 206 or a pre-processed version thereof) are provided to a depth processing operation 506 (which may be implemented as part of the depth point generation function 324). The depth processing operation 506 here includes a depth densification function 508 and a depth super-resolution function 510. The depth densification function 508 generally operates to perform depth densification to generate additional depth values not included among the depth values of the depth data 206 within the low-resolution depth map 504. For example, the depth values of the depth data 206 may mapped to a first set of points within a high-resolution but sparse depth map, and the depth densification function 508 may generate additional depth values that are mapped to a second set of points within the high-resolution depth map. In some cases, the additional depth values may be generated using a depth filter. The depth super-resolution function 510 generally operates to perform depth super-resolution to upscale the depth values (both the depth data 206 from the low-resolution depth map 504 and the depth values generated by the depth densification function 508) in order to generate depth values within a high-resolution depth map 512.

Head pose data 514 is provides to a head pose prediction function 516 (which may represent the head pose prediction function 316). The head pose prediction function 516 generally operates to predict a head pose of the user of the electronic device 101. For example, an original image frame 502 may be captured at a first time, and a rendered image based on the image frame 502 may be displayed at a second time subsequent to the first time. During the intervening period between the first and second times, the user may move his or her head. The head pose prediction function 516 can therefore predict the user's head pose at the second time, allowing reprojection to be performed (if needed) based on the user's predicted head pose change. In this particular example, the head pose prediction function 516 can use a head pose motion model to predict a future head pose of the user based on prior and current information about the user's head pose.

An image frame reprojection operation 518 (which may be implemented as part of the image point generation function 326) can use the high-resolution depth map 512 and the predicted head pose of the user to perform depth-based reprojection. In this example, the image frame reprojection operation 518 includes a reprojected frame generation function 520, which can generate new image data for a reprojected image frame 522 based on the image frame 502, the high-resolution depth map 512, and the current and predicted head poses of the user.

In some embodiments, the reprojection of the image frame 502 to generate a reprojected image frame 522 may occur as follows. Let p_{f}(x_{f}, y_{f}, z_{f}) represent a point in the reprojected image frame 522, and let p_{c}(x_{c}, y_{c}, z_{c}) represent a point in the image frame 502. The following relationship can be fined by depth-based reprojection.

$$( \begin{matrix}{x}_{f} \\ {y}_{f} \\ {z}_{f} \\ {w}_{f}\end{matrix} ) = {PH}_{f} {H}_{i}^{- 1} {P}^{- 1} ( \begin{matrix}{x}_{c} \\ {y}_{c} \\ {z}_{c} \\ {w}_{c}\end{matrix} )$$

Here, P represents a projection matrix, H_{f} represents a predicted head pose of the user, and Hᵢ represents a current head pose of the user. Based on this, the following can be defined.

$${H}_{f} = [ {R}_{f} \vert {T}_{f} ]$$

Here, R_{f} represents a rotation matrix, and T_{f} represents a translation vector. Also, the following can be defined.

$${H}_{i} = [ {R}_{i} \vert {T}_{i} ]$$

Here, Rᵢ represents a rotation matrix, and Tᵢ represents a translation vector. Using these notations, the following can be defined.

$${p}_{c} ( {x}_{c} , {y}_{c} , {z}_{c} ) = ( \begin{matrix}{x}_{c} \\ {y}_{c} \\ {z}_{c} \\ {w}_{c}\end{matrix} ) , where {z}_{c} = d .$$

Here, d represents the depth at the point p_{c}(x_{c}, y_{c}, z_{c}) obtained by performing depth densification and super-resolution.

Although FIG. 5 illustrates one example of a technique 500 for final passthrough image frame generation, various changes may be made to FIG. 5. For example, while not shown here, the process of identifying depth values may be done on a pixel-by-pixel basis as described above with respect to FIG. 3.

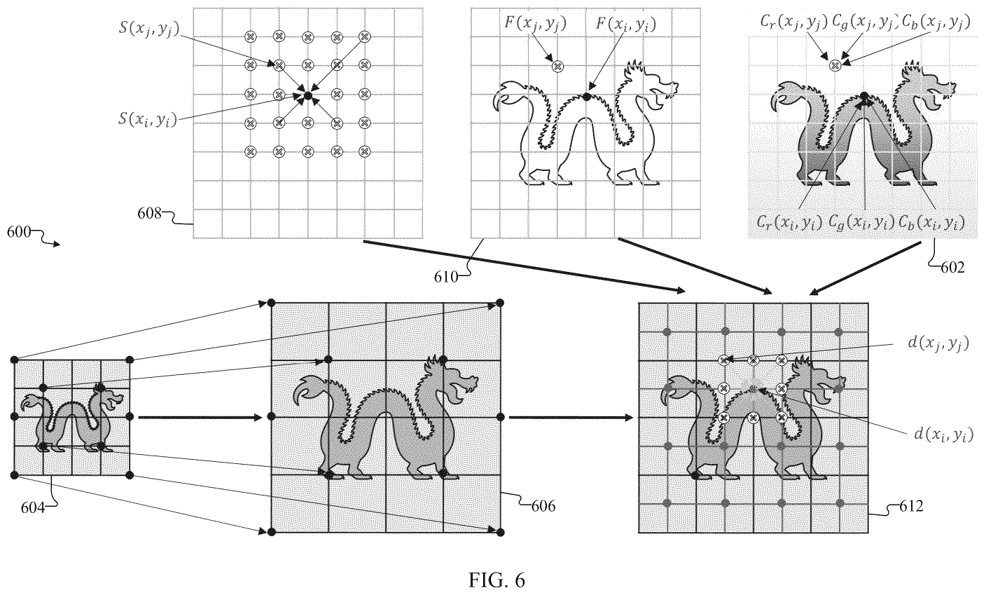

FIG. 6 illustrates an example adaptive depth densification and super-resolution 600 in accordance with this disclosure. The example here may, for instance, be performed as part of the depth-based reprojection operation 318. For ease of explanation, the example shown in FIG. 6 is described as being performed using the electronic device 101 in the network configuration 100 shown in FIG. 1, where the electronic device 101 may implement the process 200 shown in FIG. 2 and/or the architecture 300 shown in FIG. 3. However, the example shown in FIG. 6 may be performed using any other suitable device(s), process(es), and architecture(s) and in any other suitable system(s).

As shown in FIG. 6, one goal of adaptive depth densification and super-resolution 600 can be to fill in depth holes within sparse depth maps or other sparse depth data and to upscale depth data from lower resolutions to higher resolutions (such as with high-quality interpolation and clear object boundaries) in order to obtain dense depth maps or other dense depth data. In the example shown in FIG. 6, an image frame 602 is associated with a low-resolution sparse depth map 604. The low-resolution sparse depth map 604 is mapped (such as by using the depth map mapping function 314) to a high-resolution sparse depth map 606. For example, the depth map mapping function 314 can be used to map the depth values of the low-resolution sparse depth map 604 onto a first set of points in the high-resolution sparse depth map 606. In some embodiments, the high-resolution sparse depth map 606 can have a resolution that matches or is substantially similar to the resolution of the image frame 602, but a number of depth values at this point may be missing in the high-resolution sparse depth map 606.

Adaptive depth densification and super-resolution are performed using the image frame 602, the high-resolution sparse depth map 606, and optionally spatial information 608 and/or feature information 610. The spatial information 608 can relate to or include image correspondences identified within the image frame 602 and another image frame. The feature information 610 can relate to or include corresponding image feature correspondences identified within the image frame 602 and the other image frame. Examples of image correspondences and image feature correspondences are described below. The adaptive depth densification and super-resolution are used to generate a high-quality (dense) high-resolution depth map 612 with clear object boundaries.

In some cases, adaptive depth densification and super resolution may occur as follows. During adaptive depth densification and super resolution, the depth of a given point in the high-resolution depth map 612 can be determined using (i) a neighborhood of depth values S(xⱼ, yⱼ) around a given point S(xᵢ, yᵢ) within the spatial information 608, (ii) image feature information F(xⱼ, yⱼ) around a given feature F(xᵢ, yᵢ) within the feature information 610, and image color texture information Cᵣ(xⱼ, yⱼ), C_{g}(xⱼ, yⱼ), C_{b}(xⱼ, yⱼ) around a given point Cᵣ(xᵢ, yᵢ), C_{g}(xᵢ, yᵢ), C_{b}(xᵢ, yᵢ) within the image frame 602. With guidance from the image features and color textures, additional depth values can be determined in a manner so that depth-based reprojection does not significantly smooth or otherwise negatively impact object boundaries within the reprojected image frame. In some cases, each additional depth value may be expressed as follows.

$$d ( p ) = ℱ ( {w}_{s} , {w}_{f} , {w}_{c} , {w}_{t} , q ) , q ϵℕ ( p )$$

Here, d(p) represents the depth at the given point, and [symbol] (·) represents a depth filter. Also, wₛ represents a weight based on the spatial information 608, w_{f} represents a weight based on the feature information 610, w_{c} represents a weight based on the color texture information, and wₜ represents a weight based on temporal information. In addition, q represents a neighborhood of pixels around pixel p, where qϵ [symbol] (p).

Although FIG. 6 illustrates one example of adaptive depth densification and super-resolution 600, various changes may be made to FIG. 6. For example, the resolutions of the image frames and depth data are not drawn to scale here and can easily vary depending on the implementation.

FIG. 7 illustrates example image correspondences 700 for adaptive depth densification and super-resolution in accordance with this disclosure. The example here may, for instance, be performed as part of the depth-based reprojection operation 318. For case of explanation, the example shown in FIG. 7 is described as being performed using the electronic device 101 in the network configuration 100 shown in FIG. 1, where the electronic device 101 may implement the process 200 shown in FIG. 2 and/or the architecture 300 shown in FIG. 3. However, the example shown in FIG. 7 may be performed using any other suitable device(s), process(es), and architecture(s) and in any other suitable system(s).

As shown in FIG. 7, two image frames 702 and 704 (such as left and right image frames of a stereo pair) are obtained, along with a low-resolution depth map 706 associated with the image frames 702 and 704. A correspondence between a point in the image frame 702 and a point in the image frame 704 can be defined where the two image frames 702 and 704 capture the same point in a scene. For various reasons, such as different positions of imaging sensors 180 used to the capture the image frames 702 and 704, corresponding points in the image frames 702 and 704 may not be located at the same locations within the image frames 702 and 704 themselves. Correspondences between points in the image frames 702 and 704 can be used as guidance during generation of a high-resolution depth map 708, where the high-resolution depth map 708 can be used to perform depth-based reprojection as described above.

In some embodiments, image correspondences may be identified and used in the following manner. Image correspondences may be identified using various image matching approaches to obtain correspondence pairs between the left image frame (denoted I_{left}(xₗ, yₗ)) 702 and the right image frame (denoted I_{right}(xᵣ, yᵣ)) 704. These image correspondences may be defined as follows.

$${p}_{l} ( {x}_{i}^{l} , {y}_{i}^{l} ) {↔}_{match} {p}_{r} ( {x}_{i}^{r} , {y}_{i}^{r} )$$

### Here,

$${p}_{l} ( {x}_{i}^{l} , {y}_{i}^{l} )$$

represents a point in the image frame 702, and

$${p}_{r} ( {x}_{i}^{r} , {y}_{i}^{r} )$$

represents a point in the image frame 704 corresponding to the point

$${p}_{l} ( {x}_{i}^{l} , {y}_{i}^{l} ) .$$

As previously discussed, the low-resolution depth map 706 map be mapped to a high-resolution (but sparse) depth map, and depth densification and super-resolution can be performed to obtain the high-resolution depth map 708. In order to obtain depth values at empty points within the high-resolution (but sparse) depth map, a depth filter may be created as described above to calculate each unknown depth value based on the neighborhood of depth values around that unknown depth value. The neighborhood of depth values can be weighted based on weights from relevant information. In some embodiments, one of the weights represents a weight created from image correspondences, and this weight w_{c} may be defined as follows in some cases.

$${w}_{c} ( p ( {x}_{i} , {y}_{i} ) , p ( {x}_{j} , {y}_{j} ) ) = {e}^{- {( {d}_{c} - {μ}_{c} )}^{2} / 2 {σ}_{c}^{2}}$$

Here, d_{c} represents a color difference between the point p(xᵢ, yᵢ) and the point p(xⱼ, yⱼ), and (μ_{c}, σ_{c}) represents Gaussian distribution parameters for the color weight. The color values at the point p(xᵢ, yᵢ) and the point p(xⱼ, yⱼ) represent the color values at a pair of image correspondence points in the left and right image frames 702 and 704.

Although FIG. 7 illustrates one example of image correspondences 700 for adaptive depth densification and super-resolution, various changes may be made to FIG. 7. For example, the resolutions of the image frames and depth data are not drawn to scale here and can easily vary depending on the implementation. Also, the actual image correspondences will easily vary based on the image frames being processed.

FIG. 8 illustrates example image feature correspondences 800 for adaptive depth densification and super-resolution in accordance with this disclosure. The example here may, for instance, be performed as part of the depth-based reprojection operation 318. For case of explanation, the example shown in FIG. 8 is described as being performed using the electronic device 101 in the network configuration 100 shown in FIG. 1, where the electronic device 101 may implement the process 200 shown in FIG. 2 and/or the architecture 300 shown in FIG. 3. However, the example shown in FIG. 8 may be performed using any other suitable device(s), process(es), and architecture(s) and in any other suitable system(s).

As shown in FIG. 8, two image frames 802 and 804 (such as left and right image frames of a stereo pair) are obtained, along with a low-resolution depth map 806 associated with the image frames 802 and 804. An image feature map 808 is generated based on the content of the image frame 802, where the image feature map 808 identifies features in the image frame 802. Similarly, an image feature map 810 is generated based on the content of the image frame 804, where the image feature map 810 identifies features in the image frame 804. Each image feature map 808 and 810 can be generated in any suitable manner, such as by performing an image feature detection and extraction technique.

A correspondence between a feature in the image feature map 808 and a feature in the image feature map 810 is defined where the two image feature maps 808 and 810 contain the same feature. Again, for various reasons, such as different positions of imaging sensors 180 used to the capture the image frames 802 and 804, corresponding image features in the image feature maps 808 and 810 may not be located at the same locations within the image feature maps 808 and 810 themselves. Correspondences between features in the image feature maps 808 and 810 can be used as guidance during generation of a high-resolution depth map 812, where the high-resolution depth map 812 can be used to perform depth-based reprojection as described above.

In some embodiments, image feature correspondences may be identified and used in the following manner. Image feature correspondences may be identified using various feature matching approaches to obtain correspondence pairs between the left image feature map (denoted F_{left}(xₗ, yₗ)) 808 and the right image feature map (denoted F_{right}(xᵣ, yᵣ)) 810. These image feature correspondences may be defined as follows.

$${p}_{l} ( {x}_{i}^{l} , {y}_{i}^{l} ) {↔}_{match} {p}_{r} ( {x}_{i}^{r} , {y}_{i}^{r} )$$

### Here,

$${p}_{l} ( {x}_{i}^{l} , {y}_{i}^{l} )$$

represents a point in the image feature map 808, and

$${p}_{r} ( {x}_{i}^{r} , {y}_{i}^{r} )$$

represents a point in the image feature map 810 corresponding to the feature

$${p}_{l} ( {x}_{i}^{l} , {y}_{i}^{l} ) .$$

As previously discussed, the low-resolution depth map 806 map be mapped to a high-resolution (but sparse) depth map, and depth densification and super-resolution can be performed to obtain the high-resolution depth map 812. In order to obtain depth values at empty points within the high-resolution (but sparse) depth map, a depth filter may be created as described above to calculate each unknown depth value based on the neighborhood of depth values around that unknown depth value. The neighborhood of depth values can be weighted based on weights from relevant information. In some embodiments, one of the weights represents a weight created from image feature correspondences, and this weight w_{f} may be defined as follows in some cases.

$${w}_{f} ( p ( {x}_{i} , {y}_{i} ) , p ( {x}_{j} , {y}_{j} ) ) = {e}^{- {( {d}_{f} - {μ}_{f} )}^{2} / 2 {σ}_{f}^{2}}$$

Here, d_{f} represents a feature difference between the point p(xᵢ, yᵢ) and the point p(xⱼ, yⱼ), and (μ_{c}, μ_{c}) represents Gaussian distribution parameters for the feature weight. The feature values at the point p(xᵢ, yᵢ) and the point p(xⱼ, yⱼ) represent the feature values at a pair of feature correspondence points in the left and right image frames 802 and 804.

Although FIG. 8 illustrates one example of feature correspondences 800 for adaptive depth densification and super-resolution, various changes may be made to FIG. 8. For example, the resolutions of the image frames, feature maps, and depth data are not drawn to scale here and can easily vary depending on the implementation. Also, the actual feature correspondences will easily vary based on the image frames being processed.

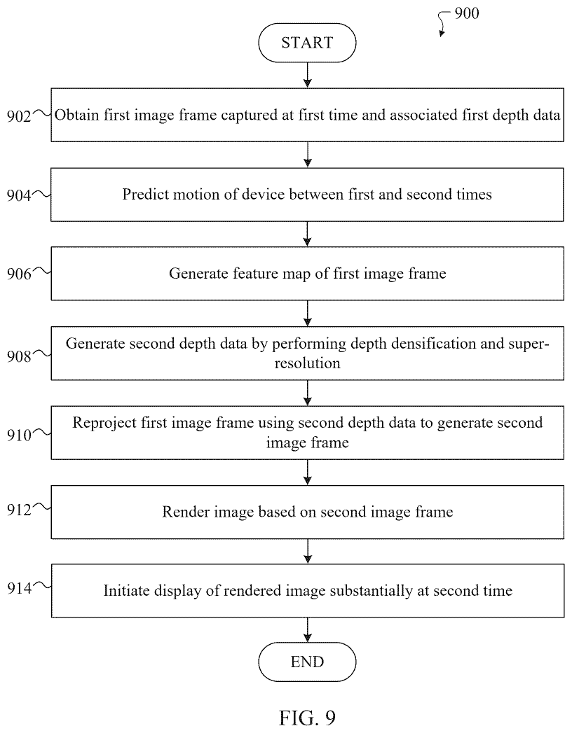

FIG. 9 illustrates an example method 900 for depth-based reprojection with adaptive depth densification and super-resolution for VST XR or other applications in accordance with this disclosure. For case of explanation, the method 900 shown in FIG. 9 is described as being performed using the electronic device 101 in the network configuration 100 of FIG. 1, where the electronic device 101 can implement the process 200 shown in FIG. 2 and/or the architecture 300 shown in FIG. 3. However, the method 900 may be performed using any other suitable device(s) and in any other suitable system(s).

As shown in FIG. 9, a first image frame and related information are obtained at step 902. This may include, for example, the processor 120 of the electronic device 101 obtaining a first image frame using at least one see-through camera or other imaging sensor 180 of the electronic device 101. This may also include the processor 120 of the electronic device 101 generating or otherwise obtaining one or more additional types of information related to the first image frame, such as first depth data. The first image frame has a higher resolution than the first depth data. The first image frame is captured or otherwise obtained at a first time.

Motion of the electronic device is predicted between the first time and a second time at step 904. This may include, for example, the processor 120 of the electronic device 101 performing head pose prediction to estimate the pose of a user's head at a second time following the first time. The second time can represent an estimated time at which a rendered image based on the first image frame will be displayed to a user of the electronic device 101. A feature map of the first image frame may optionally be generated at step 906. This may include, for example, the processor 120 of the electronic device 101 performing feature detection and extraction in order to generate a feature map for the first image frame.

Second depth data is generated by performing depth densification and super-resolution at step 908. This may include, for example, the processor 120 of the electronic device 101 performing depth densification and super-resolution based on the first depth data, the first image frame, and the predicted motion. Depth densification and super-resolution can be performed here in order to increase the resolution of the second depth data relative to the resolution of the first depth data. For instance, the resolution of the second depth data may match or substantially match the resolution of the first image frame. In some cases, depth densification and super-resolution can be performed using the feature map. Also, in some embodiments, the depth densification and super-resolution can involve mapping first depth values of the first depth data onto a first set of points and generating and mapping second depth values onto a second set of points, where the first and second depth values together form at least part of the second depth data. Here, depth densification may be performed to generate additional depth values not included among the first depth values of the first depth data, and depth super-resolution may be performed to upscale the first depth values and the additional depth values in order to generate the second depth values. In some embodiments, a depth filter can be used to generate the additional depth values based on (i) neighboring first depth values of the first depth data, (ii) information from the first image frame, and (iii) the feature map. For example, depth densification may be performed using (i) image feature information from the feature map and (ii) at least one of: spatial information, image color texture information, or temporal information from the first image frame. In particular embodiments, image correspondences and/or image feature correspondences between the first image frame and another image frame (which may represent left and right image frames of a stereo pair of image frames) can be used when performing depth densification and super-resolution.

The first image frame is reprojected using the second depth data to generate a second image frame at step 910. This may include, for example, the processor 120 of the electronic device 101 performing depth-based reprojection of the first image frame (possibly on a pixel-by-pixel basis) in order to generate the second image frame. The second image frame can be rendered at step 912, and display of the resulting rendered image can be initiated at step 914. This may include, for example, the processor 120 of the electronic device 101 rendering the second image frame and displaying the rendered image on at least one display 160 of the electronic device 101. The rendered image here can be displayed substantially at the second time.

Although FIG. 9 illustrates one example of a method 900 for depth-based reprojection with adaptive depth densification and super-resolution for VST XR or other applications, various changes may be made to FIG. 9. For example, while shown as a series of steps, various steps in FIG. 9 may overlap, occur in parallel, occur in a different order, or occur any number of times (including zero times). Also, the method 900 may be repeated for any number of image frames, such as for multiple image frames captured using left and right see-through cameras or other imaging sensors 180 of a VST XR device or other electronic device 101. In addition, while not shown here, depth-based reprojection may only be performed in some circumstances (such as when the user focuses on a 3D object), and one or more other types of reprojections (such as time warp reprojection or planar reprojection) or no reprojection may be used in other circumstances.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An apparatus comprising:
at least one display;
at least one imaging sensor configured to capture image frames of a scene;
at least one motion sensor configured to sense motion of the apparatus; and
at least one processing device configured to:
obtain a first image frame captured at a first time and first depth data associated with the first image frame, the first image frame having a higher resolution than the first depth data;
predict motion of the apparatus between the first time and a second time;
generate second depth data based on the first depth data, the first image frame, and the predicted motion, the second depth data having a higher resolution than the first depth data;
reproject the first image frame using the second depth data to generate a second image frame; and
initiate presentation of a rendered image based on the second image frame, the at least one display configured to present the rendered image substantially at the second time;
wherein, to generate the second depth data, the at least one processing device is configured to perform depth densification and super-resolution in order to increase the resolution of the second depth data relative to the resolution of the first depth data.

2. The apparatus of claim 1, wherein the resolution of the second depth data matches or substantially matches the resolution of the first image frame.

3. The apparatus of claim 1, wherein:
the at least one processing device is further configured to generate a feature map based on the first image frame; and
the at least one processing device is configured to use the feature map during depth densification and super-resolution.

4. The apparatus of claim 3, wherein, during depth densification and super-resolution, the at least one processing device is configured to:
map first depth values of the first depth data onto a first set of points;
generate second depth values; and
map the second depth values onto a second set of points such that the first depth values and the second depth values together form at least part of the second depth data.

5. The apparatus of claim 4, wherein:
the at least one processing device is configured to perform depth densification to generate additional depth values not included among the first depth values of the first depth data; and
the at least one processing device is configured to perform depth super-resolution to upscale the first depth values and the additional depth values in order to generate the second depth values.

6. The apparatus of claim 5, wherein the at least one processing device is configured to use a depth filter to generate the additional depth values based on (i) neighboring first depth values of the first depth data, (ii) information from the first image frame, and (iii) the feature map.

7. The apparatus of claim 3, wherein the at least one processing device is configured to perform depth densification using (i) image feature information from the feature map and (ii) at least one of: spatial information, image color texture information, or temporal information from the first image frame.

8. The apparatus of claim 1, wherein, to perform depth densification and super-resolution, the at least one processing device is configured to use at least one of image correspondence or image feature correspondence between the first image frame and a third image frame, the first and third image frames representing left and right image frames of a stereo pair of image frames.

9. A method comprising:
obtaining, using at least one imaging sensor of an electronic device, a first image frame captured at a first time and first depth data associated with the first image frame, the first image frame having a higher resolution than the first depth data;
predicting, using at least one processing device of the electronic device, motion of the electronic device between the first time and a second time;
generating, using the at least one processing device, second depth data based on the first depth data, the first image frame, and the predicted motion, the second depth data having a higher resolution than the first depth data;
reprojecting, using the at least one processing device, the first image frame using the second depth data to generate a second image frame; and
displaying, using at least one display of the electronic device, a rendered image based on the second image frame;
wherein generating the second depth data comprises performing depth densification and super-resolution in order to increase the resolution of the second depth data relative to the resolution of the first depth data.

10. The method of claim 9, wherein the resolution of the second depth data matches or substantially matches the resolution of the first image frame.

11. The method of claim 9, further comprising:
generating a feature map based on the first image frame;
wherein the feature map is used during depth densification and super-resolution.

12. The method of claim 11, wherein performing depth densification and super-resolution comprises:
mapping first depth values of the first depth data onto a first set of points;
generating second depth values; and
mapping the second depth values onto a second set of points such that the first depth values and the second depth values together form at least part of the second depth data.

13. The method of claim 12, wherein:
depth densification is performed to generate additional depth values not included among the first depth values of the first depth data; and
depth super-resolution is performed to upscale the first depth values and the additional depth values in order to generate the second depth values.

14. The method of claim 13, wherein a depth filter is used to generate the additional depth values based on (i) neighboring first depth values of the first depth data, (ii) information from the first image frame, and (iii) the feature map.

15. The method of claim 11, wherein depth densification is performed using (i) image feature information from the feature map and (ii) at least one of: spatial information, image color texture information, or temporal information from the first image frame.

16. The method of claim 9, wherein depth densification and super-resolution are performed using at least one of image correspondence or image feature correspondence between the first image frame and a third image frame, the first and third image frames representing left and right image frames of a stereo pair of image frames.

17. A non-transitory machine readable medium containing instructions that when executed cause at least one processor of an electronic device to:
obtain, using at least one imaging sensor of the electronic device, a first image frame captured at a first time and first depth data associated with the first image frame, the first image frame having a higher resolution than the first depth data;
predict motion of the electronic device between the first time and a second time;
generate second depth data based on the first depth data, the first image frame, and the predicted motion, the second depth data having a higher resolution than the first depth data;
reproject the first image frame using the second depth data to generate a second image frame; and
initiate display of a rendered image based on the second image frame;
wherein the instructions that when executed cause the at least one processor to generate the second depth data comprise instructions that when executed cause the at least one processor to perform depth densification and super-resolution in order to increase the resolution of the second depth data relative to the resolution of the first depth data.

18. The non-transitory machine readable medium of claim 17, wherein the instructions that when executed cause the at least one processor to perform depth densification and super-resolution comprise instructions that when executed cause the at least one processor to:
map first depth values of the first depth data onto a first set of points;
generate second depth values; and
map the second depth values onto a second set of points such that the first depth values and the second depth values together form at least part of the second depth data.

19. The non-transitory machine readable medium of claim 18, wherein:
the instructions that when executed cause the at least one processor to perform depth densification comprise instructions that when executed cause the at least one processor to generate additional depth values not included among the first depth values of the first depth data; and
the instructions that when executed cause the at least one processor to perform depth super-resolution comprise instructions that when executed cause the at least one processor to upscale the first depth values and the additional depth values in order to generate the second depth values.

20. The on-transitory machine readable medium of claim 19, further containing instructions that when executed cause the at least one processor to generate a feature map based on the first image frame;
wherein the instructions when executed cause the at least one processor to use a depth filter to generate the additional depth values based on (i) neighboring first depth values of the first depth data, (ii) information from the first image frame, and (iii) the feature map.
